(19) United States
(12) Patent Application Publication
(10) Pub. No.: US 2026/0356385 A1
(43) Pub. Date: Nov. 12, 2026

(54) DETERMINING AN INTENTION TO PARK A VEHICLE

(71) Applicant: Robert Bosch GmbH, Stuttgart (DE)

(72) Inventors: John David Nowinski, Sylvania, OH (US); Elizabeth Emay Kao, Northville, MI (US); Auston Varghese Payyappilly, Novi, MI (US); Matthew Michael Coon, Plymouth, MI (US); Nils-Jochen Bannow, Hildesheim (DE)

(21) Appl. No.: 19/305,364

(22) Filed: Aug. 20, 2025

Related U.S. Application Data
(60) Provisional application No. 63/804,363, filed on May 12, 2025.

(51) Int. Cl. B60W 50/10; B60W 30/06; B60W 50/00; B60W 50/08; B60W 60/00

(52) U.S. Cl. CPC B60W 50/10; B60W 30/06; B60W 50/082; B60W 2050/0022; B60W 60/001; B60W 2520/10; B60W 2540/215; B60W 2540/223; B60W 2540/225; B60W 2540/30

(57) ABSTRACT

A system for determining an intention to park a vehicle. The system includes an electronic processor. The electronic processor is configured to, for each behavior characteristic, determine a partial behavior characteristic score based on a behavior confidence value and a weight. The electronic processor is also configured to determine a behavior characteristic score based on the partial behavior characteristic scores. The electronic processor is further configured to, for each parking situation characteristic, determine a partial parking situation characteristic score based on a parking situation confidence value and a weight. The electronic processor is also configured to determine a parking situation characteristic score based on the partial parking situation characteristic scores and, in response to the behavior characteristic score being greater than a first predetermined threshold and the parking situation characteristic score being greater than a second predetermined threshold, generate a notification regarding an offer to automatically assist parking the vehicle.

### SUMMARY

Many vehicles today are equipped with automated parking assist (APA). However, many drivers do not utilize APA because they are unaware it exists or are unsure how to access APA when they want to park. Some implementations described herein provide a system and method for automatically offering to activate APA when it is determined that a driver intends to park a vehicle. The system and method described herein may utilize a plurality of factors and weights to ensure that notifications regarding offers to activate APA are unlikely to be generated when a driver does not intend to park the vehicle and, therefore, do not disturb the driver.

One example implementation provides a system for determining an intention to park a vehicle. The system includes an electronic processor. The electronic processor is configured to, for each behavior characteristic of a plurality of behavior characteristics, determine a behavior confidence value and determine a partial behavior characteristic score based on the behavior confidence value and a weight associated with the behavior characteristic. The behavior confidence value indicates a likelihood of intention to park based on the behavior characteristic. The electronic processor is also configured to determine a behavior characteristic score based on the partial behavior characteristic scores. The electronic processor is further configured to, for each parking situation characteristic of a plurality of parking situation characteristics, determine a parking situation confidence value and determine a partial parking situation characteristic score based on the parking situation confidence value and a weight associated with the parking situation characteristic. The parking situation confidence value indicates a likelihood of intention to park based on the parking situation characteristic. The electronic processor is further configured to determine a parking situation characteristic score based on the partial parking situation characteristic scores and, in response to the behavior characteristic score being greater than a first predetermined threshold and the parking situation characteristic score being greater than a second predetermined threshold, generate a notification regarding an offer to automatically assist parking the vehicle.

Another example implementation provides a method for determining an intention to park a vehicle. The method includes, for each behavior characteristic of a plurality of behavior characteristics, determining a behavior confidence value and determining a partial behavior characteristic score based on the behavior confidence value and a weight associated with the behavior characteristic. The behavior confidence value indicates a likelihood of intention to park based on the behavior characteristic. The method further includes determining a behavior characteristic score based on the partial behavior characteristic scores. The method also includes, for each parking situation characteristic of a plurality of parking situation characteristics, determining a parking situation confidence value and determining a partial parking situation characteristic score based on the parking situation confidence value and a weight associated with the parking situation characteristic. The parking situation confidence value indicates a likelihood of intention to park based on the parking situation characteristic. The method also includes determining a parking situation characteristic score based on the partial parking situation characteristic scores and in response to the behavior characteristic score being greater than a first predetermined threshold and the parking situation characteristic score being greater than a second predetermined threshold, generating a notification regarding an offer to automatically assist parking the vehicle.

### BRIEF DESCRIPTION OF THE DRAWINGS

FIG. 1 is a block diagram of an example system for determining an intention to park a vehicle, in accordance with some implementations.

FIG. 2 is a block diagram of an example electronic control unit included in the system of FIG. 1, in accordance with some implementations.

FIG. 3A and FIG. 3B are an example flow chart of a method for determining an intention to park a vehicle, in accordance with some implementations.

FIG. 4 is an example flowchart of a method for determining an intention to park a vehicle, in accordance with some implementations.

### DETAILED DESCRIPTION

Before any implementations, examples, aspects, and features are explained in detail, it is to be understood that they are not limited in their application to the details of construction and the arrangement of components set forth in the following description or illustrated in the following drawings. Other implementations, examples, aspects, and features are possible, and they are capable of being practiced or of being carried out in various ways.

For ease of description, some or all of the example systems presented herein are illustrated with a single exemplar of each of its component parts. Some examples may not describe or illustrate all components of the systems. Other examples may include more or fewer of each of the illustrated components, may combine some components, or may include additional or alternative components.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some implementations, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

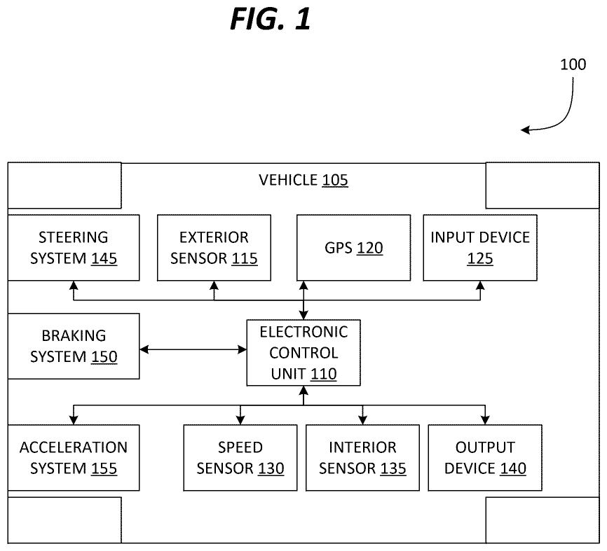

FIG. 1 illustrates an example system 100 for determining an intention to park a vehicle. In the schematic illustration of FIG. 1, the system 100 is included in a vehicle 105. While illustrated in FIG. 1 as a four-wheel vehicle, the vehicle 105 may be a different type of vehicle, for example, a two-wheel vehicle such as a motorcycle, a three-wheel vehicle such as a trike, or an eight-wheel vehicle such as a semi-truck. In the illustrated implementation, the system 100 includes an electronic control unit (ECU) 110, an exterior sensor 115, a global positioning system (GPS) 120, an input device 125, a speed sensor 130, an interior sensor 135, an output device 140, a steering system 145, a braking system 150, and an acceleration system 155. The acceleration system 155 refers to components that propel the vehicle 105 including for example, the vehicle engine or motor and drivetrain components, including electronic controls or controllers of such systems. While illustrated in FIG. 1 as a single sensor, the exterior sensor 115 may be a plurality of sensors configured to capture data regarding the environment surrounding the vehicle 105. In some instances, the exterior sensor 115 is a camera, a radar sensor, a lidar sensor, a combination of the foregoing, or the like. While illustrated in FIG. 1 as a single sensor, the interior sensor 135 may be a plurality of sensors configured to capture data regarding the interior of the vehicle and, in certain instances, a driver of the vehicle 105. In some instances, the interior sensor 135 is a camera. The output device 140 may be a display device, a light emitting diode (LED), a speaker, or the like. The input device 125 may be a physical button, a touchscreen, a microphone, or the like.

In some implementations, the ECU 110 is electrically connected coupled to the exterior sensor 115, the GPS 120, the input device 125, the speed sensor 130, the interior sensor 135, the output device 140, the steering system 145, the braking system 150, and the acceleration system 155 via direct or indirect connections or by or through one or more control or data buses, which enable communication therebetween. In some instances, the bus is a Controller Area Network (CAN™) bus. In some instances, the bus is an automotive Ethernet™, a FlexRay™ communications bus, or another suitable bus. In alternative instances, some or all of the components of the vehicle 105 may be connected using suitable wireless modalities (for example, Bluetooth™ or near field communication connections). Connections illustrated in FIG. 1 as being unidirectional may be, in some implementations, bidirectional. Connections illustrated in FIG. 1 as being bidirectional may be, in some implementations, unidirectional.

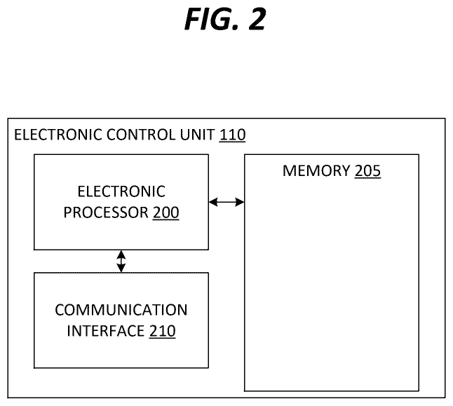

FIG. 2 illustrates an example of the components included in the ECU 110. In the example shown, the ECU 110 includes an electronic processor 200 (for example, a microprocessor, application specific integrated circuit, etc.), a memory 205, and a communication interface 210. The memory 205 may be made up of one or more non-transitory computer-readable media. The memory 205 can include combinations of different types of memory, such as read-only memory (“ROM”), random access memory (“RAM”), electrically erasable programmable read-only memory (“EEPROM”), flash memory, or other suitable memory devices. The electronic processor 200 is coupled to the memory 205 and the communication interface 210. The electronic processor 200 sends and receives information (for example, from the memory 205 and/or the communication interface 210) and processes the information by executing one or more software instructions or modules, capable of being stored in the memory 205, or another non-transitory computer readable medium. The software can include firmware, one or more applications, program data, filters, rules, one or more program modules, and other executable instructions. In some examples, the electronic processor 200 is configured to retrieve from the memory 205 and execute, among other things, software for performing methods as described herein.

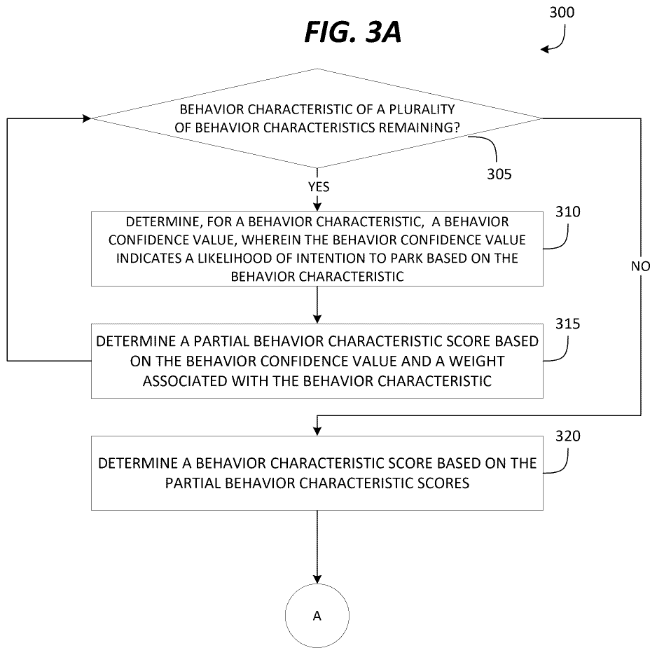

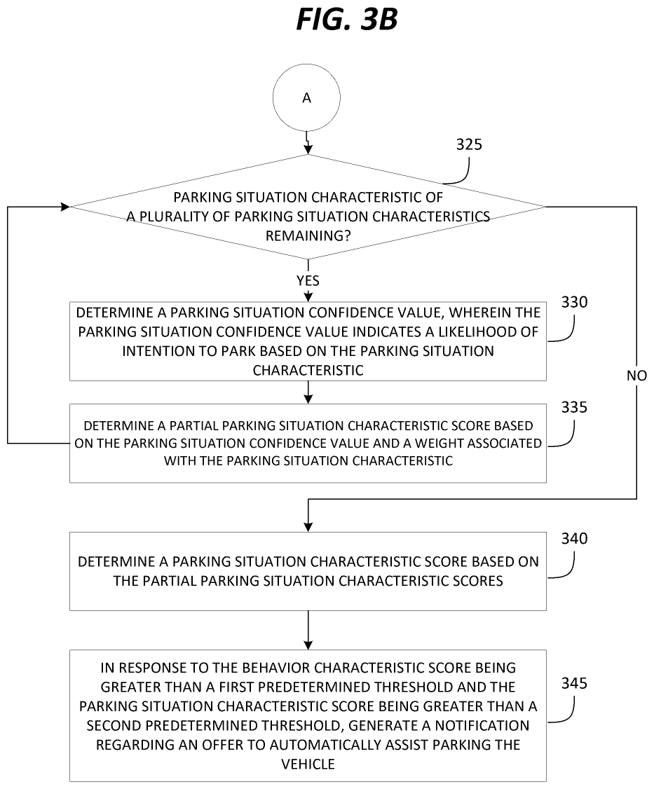

FIG. 3A and FIG. 3B are an example flow chart of a method 300 for determining an intention to park a vehicle. The functionality described in relation to the blocks illustrated in FIGS. 3A and 3B may be performed in a variety of orders. For example, the functionality described in relation to blocks 325-340 may be performed prior to the functionality described in relation to blocks 305-320. In such implementations, the functionality described in relation to blocks 305-320 and 345 may be performed in response to a parking situation characteristic score (described below) being above a predetermined threshold. In other implementations, the electronic processor 200 performs the functionality described in relation to blocks 305-320 prior to performing the functionality described in relation to blocks 325-340. In other implementations, the functionality described in relation to blocks 305-320 is performed in parallel with the functionality described in relation to blocks 325-340.

In some implementations, the method 300 begins at block 305 when the electronic processor 200 determines whether there remains a behavior characteristic of a plurality of behavior characteristics for which a behavior confidence value has not been calculated. In some implementations, prior to performing the functionality described in relation to block 305, the electronic processor 200 determines whether a no parking intention condition is met. For example, a no parking intention condition is met when the speed of the vehicle 105 is determined by the electronic processor 200 to be above a predetermined speed threshold based on data received from the speed sensor 130. In another example, the electronic processor 200 determines whether the location of the vehicle 105 matches one of one or more locations where a driver does not wish to engage automatic parking. The electronic processor 200 may receive the one or more locations via the input device 125 and associate the received one or more locations with a face of a driver detected based on data captured by the interior sensor 135. In some implementations, the electronic processor 200 determines the one or more locations where a driver does not wish to engage automatic parking based on receiving rejections of an offer to automatically assist with parking the vehicle 105. For example, when a driver (determined based on facial recognition using data from the interior sensor 135) rejects an offer to automatically assist with parking the vehicle 105 at least a predetermined number of times at a location, the electronic processor 200 adds the location to the one or more locations where the driver does not wish to engage automatic parking. When the face of the driver is detected at a later point in time and the location of the vehicle matches one of the one or more received or determined locations where the driver does not wish to engage automatic parking, the electronic processor 200 determines that a no parking intention condition is met. In yet another example, the electronic processor 200 determines that a no parking intention condition is met when less than a predetermined amount of time (for example, two minutes) has passed since the vehicle 105 was in park.

The phrase “automatically assist parking the vehicle,” as used herein, may mean performing some aspects of parking the vehicle 105 autonomously and/or requiring a driver to monitor autonomous functionality of the vehicle 105 and take control of the vehicle 105 when necessary (parking the vehicle 105 semi-autonomously). The phrase “automatically assist parking the vehicle 105,” as used herein, may also mean parking the vehicle 105 without human intervention (parking the vehicle 105 fully autonomously).

In some implementations, the electronic processor 200 proceeds to perform the functionality described in relation to block 305 in response to determining that a no parking intention condition is not met. When a no parking intention condition is met, the electronic processor 200 determines that a notification to offer to automatically assist parking the vehicle should not be generated and my not perform the method 300.

In some implementations, when the electronic processor 200 determines that there remains a behavior characteristic of a plurality of behavior characteristics for which a behavior confidence value has not been calculated, the electronic processor 200, at block 310, determines, for a behavior characteristic, a behavior confidence value. The behavior confidence value indicates a likelihood of intention to park based on the behavior characteristic.

Behavior characteristics may include driver gaze and head position, driver posture, driver eye openness, learned driver behavior, and vehicle speed. In some implementations, fewer, additional, or different behavior characteristics may be utilized when the method 300 is performed. For example, other behavior characteristics that may be utilized include driver shoulder movement and brake application.

In one example, when a driver is moving their head left and right (for example, between 30 and 160 degrees) and scanning an area outside of the vehicle with their eyes, the electronic processor 200 determines a high confidence value associated with the behavior characteristic “driver gaze and head position.” In some implementations, the electronic processor 200 uses a machine learning model to analyze image data from the interior sensor 135 to determine a confidence value representing a likelihood that the driver moved their head left and right and scanned for a parking space. In some implementations, the confidence value assigned to the behavioral characteristic “driver gaze and head position” is the confidence value determined by the machine learning model.

In another example, when a driver sits up and improves their posture, the electronic processor 200 determines a high confidence value for the behavior characteristic “driver posture.” In some implementations, the electronic processor 200 uses a machine learning model to analyze image data from the interior sensor 135 to determine a confidence value representing the confidence of the machine learning model that the driver sat up and improved their posture. In some implementations, the confidence value assigned to the behavioral characteristic “driver posture” is the confidence value determined by the machine learning model.

In another example, when a driver widens their eyes and/or blinks less, the electronic processor 200 determines a high confidence value associated with the behavioral characteristic “driver eye openness.” In some implementations, the electronic processor 200 uses a machine learning model to analyze image data from the interior sensor 135 to determine a confidence value representing the confidence of the machine learning model that the driver widened their eyes or blinked less frequently in the image data. In some implementations, the confidence value assigned to the behavioral characteristic “driver eye openness” is the confidence value determined by the machine learning model.

In some implementations, the electronic processor 200 learns driver parking behavior. For example, the interior sensor 135 may capture image data of a driver in the moments leading up to the driver performing a parking maneuver. The electronic processor 200 may utilize the image data of the driver in the moments leading up to the driver performing a parking maneuver to train a machine learning model to predict whether the driver wishes to park based on image data of the driver. For example, a driver may usually run their fingers through their hair when they are looking to park. Over time, the machine learning model may learn that when a driver runs their fingers through their hair, the driver likely wants to park. Thus, for example, when the driver runs their fingers through their hair, the electronic processor 200, executing the machine learning model, determines a high confidence value for the behavioral characteristic “learned driver behavior.”

In another example, when the speed of the vehicle 105 is below a predetermined threshold and the vehicle 105 is not following another vehicle, the electronic processor 200 determines a high confidence value associated with the behavioral characteristic “vehicle speed.” In oner example, the electronic processor 200 determines that the speed of the vehicle 105 is below a predetermined threshold based on data received from the speed sensor 130 and determine that the vehicle 105 is not following another vehicle based on data from the exterior sensor 115. In some instances, the vehicle 105 following another vehicle indicates that the vehicle 105 is moving slowly due to traffic rather than looking for a place to park.

Returning to FIG. 3A, at block 315, the electronic processor 200 may determine a partial behavior characteristic score based on the behavior confidence value and a weight associated with the behavior characteristic. In some implementations, the electronic processor 200 multiplies the behavior confidence value by a weight associated with the behavior characteristic to determine a partial behavior characteristic score. In some implementations, each behavior characteristic is associated with a unique weight. For example, the behavior characteristic “driver gaze and head position,” and the behavior characteristic “vehicle speed” may be associated with greater weights than the behavior characteristic “driver posture,” the behavior characteristic “driver eye openness,” and the behavior characteristic “learned driver behavior” because the behavior characteristic “driver gaze and head position,” and the behavior characteristic “vehicle speed” more strongly indicate a driver's intention to park compared to the behavior characteristic “driver posture,” the behavior characteristic “driver eye openness,” and the behavior characteristic “learned driver behavior.”

After performing the functionality described in relation to block 315, the electronic processor 200 may return to block 305 to determine whether there remains a behavior characteristic of a plurality of behavior characteristics for which a behavior confidence value has not been calculated. When there are no remaining behavior characteristics for which a behavior confidence value has not been calculated (in other words, a partial behavior characteristic score is calculated for each behavior characteristic), the electronic processor 200 may perform the functionality described in relation to block 320. In some implementations, at block 320, the electronic processor 200 determines a behavior characteristic score that is based on the partial behavior characteristic scores. In some implementations, the behavior characteristic score is the sum of the partial behavior characteristic scores.

In some implementations, at block 325, the electronic processor 200 determines whether there remains a parking situation characteristic of a plurality of parking situation characteristics for which a parking situation confidence value has not been calculated. When the electronic processor 200 determines that there remains a parking situation characteristic of a plurality of parking situation characteristics for which a parking situation confidence value has not been calculated, the electronic processor 200 may proceed to perform the functionality described in relation to block 330. In some implementations, at block 330, the electronic processor 200 determines a parking situation confidence value. The parking situation confidence value may indicate a likelihood of intention to park based on the parking situation characteristic.

The parking situation characteristics may include driver gaze and head position, parking environment, point in journey, and vehicle location. In some implementations, fewer, additional, or different parking situation characteristics may be utilized when the method 300 is performed.

In one example, when a driver is gazing down lanes or roadways as the vehicle 105 passes the lanes and roadways (referred to herein as “telegraphing”), the electronic processor 200 determines a high confidence value associated with the behavior characteristic “driver gaze and head position.” In some implementations, the electronic processor 200 uses a machine learning model to analyze image data from the interior sensor 135 to determine a confidence value representing a likelihood that the driver is telegraphing. In some implementations, the confidence value assigned to the parking situation characteristic “driver gaze and head position” is the confidence value determined by the machine learning model.

In another example, when the electronic processor 200 determines that the vehicle 105 is likely in a parking environment, the electronic processor 200 determines a high confidence value associated with the behavior characteristic “parking environment.” In some implementations, the electronic processor 200 uses a machine learning model to analyze image data, radar data, lidar data, or a combination of the foregoing from the exterior sensor 115 to determine a confidence value representing a likelihood that the vehicle 105 is in a parking environment (for example, a parking lot or a parking garage). In one example, the electronic processor 200 executing the machine learning model determines that the vehicle 105 is likely located in a parking environment when the data from the exterior sensor 115 indicates that the environment includes parking spaces (for example, parking lines), vehicles arranged in a parking pattern, curbstones, parking barriers, a combination of the foregoing, or the like. In some implementations, the confidence value assigned to the parking situation characteristic “parking environment” is the confidence value determined by the machine learning model.

In another example, when the vehicle 105 has been traveling (for example, when the vehicle 105 is in drive) for at least a predetermined amount of time, when a navigation system included in the vehicle 105 or communicatively connected to the vehicle 105 indicates that the vehicle 105 has reached a destination, when the vehicle 105 has been running for at least a predetermined amount of time, when the vehicle 105 exited a parking space at least a predetermined amount of time ago, a combination of the foregoing, or the like, the electronic processor 200 determines a high confidence value associated with the behavior characteristic “point in journey.” In some implementations, the electronic processor 200 uses a machine learning model to analyze data from the exterior sensor 115, clock data, and navigation system data to determine a confidence value representing a likelihood that the vehicle 105 has reached the end of a journey. In some implementations, the confidence value assigned to the parking situation characteristic “point in journey” is the confidence value determined by the machine learning model. In some implementations, the electronic processor 200 executes an algorithm other than a machine learning model to determine a confidence value for the parking situation characteristic “point in journey.”

In another example, when the electronic processor 200 determines the vehicle 105 is in a parking environment based on a GPS location from the GPS 120 and environment data from the exterior sensor 115, the electronic processor 200 determines a high confidence value associated with the behavior characteristic “vehicle location.” In some implementations, the electronic processor 200 uses high-definition (HD) map data to determine a precise location of the vehicle 105 based on the GPS location of the vehicle 105 and the environment data captured by the exterior sensor 115. In some implementations, the electronic processor 200 sends the location of the vehicle 105 to a remote database and receives, from the remote database, an indication of whether the vehicle 105 is located in a parking environment.

Returning to FIG. 3B, in some implementations, at block 335, the electronic processor 200 determines a partial parking situation characteristic score based on the parking situation confidence value and a weight associated with the parking situation characteristic. In some implementations, the electronic processor 200 multiplies the parking situation confidence value by a weight associated with the parking situation characteristic to determine a partial parking situation characteristic score. In some implementations, each parking situation characteristic is associated with a unique weight.

After performing the functionality described in relation to block 335, the electronic processor 200 may return to block 325 to determine whether there remains a parking situation characteristic of a plurality of parking situation characteristics for which a parking situation confidence value has not been calculated. When there are no remaining parking situation characteristics for which a parking situation confidence value has not been calculated (in other words, a partial parking situation characteristic score is calculated for each parking situation characteristic), the electronic processor 200 may perform the functionality described in relation to block 340. In some implementations, at block 340, the electronic processor 200 determines a parking situation characteristic score based on the partial parking situation characteristic scores. In some implementations, the parking situation characteristic score is the sum of the partial parking situation characteristic scores.

In some implementations, at block 345, the electronic processor 200, in response to determining that the behavior characteristic score is greater than a first predetermined threshold and the parking situation characteristic score is greater than a second predetermined threshold, generates a notification regarding an offer to automatically assist parking the vehicle 105.

In some implementations, the electronic processor 200, in response to the behavior characteristic score being greater than a first predetermined threshold and the parking situation characteristic score being greater that a second predetermined threshold, determines whether a no parking intention condition is met. Examples of no parking intention conditions are described above. In some implementations, in response to determining the no parking intention condition is not met, the electronic processor 200 generates a notification regarding an offer to automatically assist parking the vehicle. In some implementations, in response to determining the no parking intention condition is met, the electronic processor 200 does not generate a notification regarding an offer to automatically assist parking the vehicle. In some implementations, determining the no parking intention condition is not met the electronic processor 200 determines whether one or more available parking spaces exist for the vehicle 105 to park in. In some implementations, in response to determining one or more available parking spaces exist for the vehicle 105 to park in, the electronic processor 200 generates a notification regarding an offer to automatically assist parking the vehicle. In some implementations, in response to determining one or more available parking spaces do not exist for the vehicle 105 to park in, the electronic processor 200 does not generate a notification regarding an offer to automatically assist parking the vehicle.

In some implementations, the generated notification is output via a speaker (the output device 140). In some implementations, the generated notification is output via a display device (the output device 140). In some implementations, the generated notification is output when an LED illuminates a symbol on a button (the output device 140) (for example, a button located on a steering wheel of the vehicle 105).

In some implementations, the electronic processor 200 receives an acceptance of the offer to automatically assist parking the vehicle. For example, the electronic processor 200 may receive the acceptance via a microphone (the input device 125). In some implementations, the electronic processor 200 receives the acceptance via a touchscreen (the input device 125). In some implementations, the electronic processor 200 receives the acceptance when the button with the illuminated symbol (the input device 125) is pressed.

In some implementations, in response to receiving the acceptance of the offer to automatically park the vehicle 105, the electronic processor 200 automatically parks the vehicle 105 in an available parking space by generating and sending commands to the steering system 145, the braking system 150, the acceleration system 155, or a combination of the forgoing to maneuver the vehicle 105 into the available parking space. In some implementations, the electronic processor 200 receives a selection of the available parking space via the touchscreen (the input device 125). For example, the notification displayed on the display device includes one or more available parking spaces and the electronic processor 200 receives the acceptance of the offer to automatically park the vehicle 105 when the electronic processor 200 receives, via the touch screen, a selection of one of the displayed available parking spaces. In other implementations, the electronic processor 200 executes automatic parking assistance (APA) in response to receiving the acceptance of the offer to automatically park the vehicle 105 and, while executing the APA, determines one or more available parking spaces. In some implementations, the electronic processor 200 displays an additional notification including the one or more available parking spaces determined by the electronic processor 200 in response to receiving the acceptance of the offer to automatically park the vehicle 105. In some implementations, the electronic processor 200 receives a selection of an available parking space of the one or more available parking spaces. In other implementations, the electronic processor 200 selects the available parking space to park the vehicle 105 automatically, without user input. In some implementations, the electronic processor 200 executes the APA to park the vehicle 105 in one of the one or more available parking spaces (for example, the selected parking space). In some implementations, the APA is a software program included in the memory 205. When the electronic processor 200 executes APA the vehicle 105 may park in an autonomous or semi-autonomous manner.

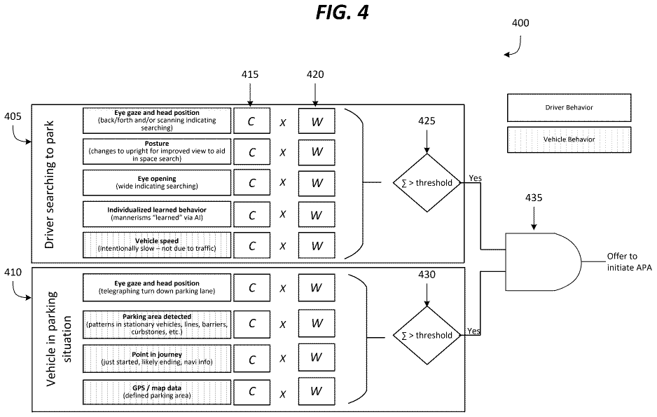

FIG. 4 is another example flowchart of a method 400 for determining an intention to park a vehicle. Block 405 includes an example of behavior characteristics and calculations associated with the behavior characteristics. Block 410 includes an example of parking situation characteristics and the calculations associated with the parking situation characteristics. Blocks 415 including a ‘C’ represent, for each characteristic, a confidence determined for the characteristic. Blocks 420 including a ‘W’ represent, for each characteristic, a weight associated with the characteristic. Block 425 represents determining whether a behavior characteristic score is greater than a first predetermined threshold. Block 430 represents determining whether a parking situation characteristic score is greater than a second predetermined threshold. The AND gate 435 represents generating a notification regarding an offer to automatically assist parking the vehicle 105 in response to determining whether the behavior characteristic score is greater than the first predetermined threshold and the parking situation characteristic score is greater than the second predetermined threshold.

Thus, examples, aspects, and features herein provide, among other things, systems and methods for determining an intention to park a vehicle.

What is claimed is:

1. A system for determining an intention to park a vehicle, the system comprising:
an electronic processor, the electronic processor configured to:
for each behavior characteristic of a plurality of behavior characteristics,
determine a behavior confidence value, wherein the behavior confidence value indicates a likelihood of intention to park based on the behavior characteristic; and
determine a partial behavior characteristic score based on the behavior confidence value and a weight associated with the behavior characteristic;
determine a behavior characteristic score based on the partial behavior characteristic scores;
for each parking situation characteristic of a plurality of parking situation characteristics,
determine a parking situation confidence value, wherein the parking situation confidence value indicates a likelihood of intention to park based on the parking situation characteristic; and
determine a partial parking situation characteristic score based on the parking situation confidence value and a weight associated with the parking situation characteristic;
determine a parking situation characteristic score based on the partial parking situation characteristic scores; and
in response to the behavior characteristic score being greater than a first predetermined threshold and the parking situation characteristic score being greater than a second predetermined threshold, generate a notification regarding an offer to automatically assist parking the vehicle.

2. The system according to claim 1, the electronic processor configured to:
receive an acceptance of the offer to automatically assist park the vehicle; and
in response to receiving the acceptance of the offer to automatically park the vehicle, automatically park the vehicle in an available parking space.

3. The system according to claim 1, wherein the electronic processor is configured to determine a partial behavior characteristic score based on the behavior confidence value and a weight associated with the behavior characteristic by:
multiplying the behavior confidence value by the weight associated with the behavior characteristic to determine the partial behavior characteristic score.

4. The system according to claim 1, wherein the electronic processor is configured to determine a partial parking situation characteristic score based on the parking situation confidence value and a weight associated with the parking situation characteristic by:
multiplying the parking situation confidence value by the weight associated with the parking situation characteristic to determine the partial parking situation characteristic score.

5. The system according to claim 1, wherein the parking situation characteristic score is a sum of the partial parking situation characteristic scores and the behavior characteristic score is a sum of the partial parking situation characteristic scores.

6. The system according to claim 1, the electronic processor configured to:
receive an acceptance of the offer to automatically assist park the vehicle;
in response to receiving the acceptance of the offer to automatically park the vehicle, execute automatic parking assist to determine an available parking space; and
in response to determining the available parking space, park the vehicle in the available parking space.

7. The system according to claim 1, wherein the behavior characteristics include driver gaze and head position, driver posture, driver eye openness, learned driver behavior, and vehicle speed.

8. The system according to claim 1, wherein the parking situation characteristics include driver gaze and head position, parking environment, point in journey, and vehicle location.

9. The system according to claim 1, the electronic processor configured to:
in response to the behavior characteristic score being greater than the first predetermined threshold and the parking situation characteristic score being greater than the second predetermined threshold, determine whether a no parking intention condition is met; and
in response to determining the no parking intention condition is not met, generate the notification regarding the offer to automatically assist parking the vehicle.

10. The system according to claim 1, the electronic processor configured to:
determine whether a no parking intention condition is met; and
in response to determining the no parking intention condition is not met,
for each of the plurality of behavior characteristics,
determine the behavior confidence value, wherein the behavior confidence value indicates the likelihood of intention to park based on the behavior characteristic; and
determine the partial behavior characteristic score based on the behavior confidence value and the weight associated with the behavior characteristic;
determine the behavior characteristic score based on the partial behavior characteristic scores;
for each of the plurality of parking situation characteristics,
determine the parking situation confidence value, wherein the parking situation confidence value indicates the likelihood of intention to park based on the parking situation characteristic; and
determine the partial parking situation characteristic score based on the parking situation confidence value and the weight associated with the parking situation characteristic;
determine the parking situation characteristic score based on the partial parking situation characteristic scores; and
in response to the behavior characteristic score being greater than the first predetermined threshold and the parking situation characteristic score being greater than the second predetermined threshold, generate the notification regarding an offer to automatically assist parking the vehicle.

11. A method for determining an intention to park a vehicle, the method comprising:
for each behavior characteristic of a plurality of behavior characteristics,
determining a behavior confidence value, wherein the behavior confidence value indicates a likelihood of intention to park based on the behavior characteristic; and
determining a partial behavior characteristic score based on the behavior confidence value and a weight associated with the behavior characteristic;
determining a behavior characteristic score based on the partial behavior characteristic scores;
for each parking situation characteristic of a plurality of parking situation characteristics,
determining a parking situation confidence value, wherein the parking situation confidence value indicates a likelihood of intention to park based on the parking situation characteristic; and
determining a partial parking situation characteristic score based on the parking situation confidence value and a weight associated with the parking situation characteristic;
determining a parking situation characteristic score based on the partial parking situation characteristic scores; and
in response to the behavior characteristic score being greater than a first predetermined threshold and the parking situation characteristic score being greater than a second predetermined threshold, generating a notification regarding an offer to automatically assist parking the vehicle.

12. The method according to claim 11, the method further comprising:
receiving an acceptance of the offer to automatically assist park the vehicle; and
in response to receiving the acceptance of the offer to automatically park the vehicle, automatically parking the vehicle in an available parking space.

13. The method according to claim 11, wherein determining a partial behavior characteristic score based on the behavior confidence value and a weight associated with the behavior characteristic includes:
multiplying the behavior confidence value by the weight associated with the behavior characteristic to determine the partial behavior characteristic score.

14. The method according to claim 11, wherein determining a partial parking situation characteristic score based on the parking situation confidence value and a weight associated with the parking situation characteristic includes:
multiplying the parking situation confidence value by the weight associated with the parking situation characteristic to determine the partial parking situation characteristic score.

15. The method according to claim 11, wherein the parking situation characteristic score is a sum of the partial parking situation characteristic scores and the behavior characteristic score is a sum of the partial behavior characteristic scores.

16. The method according to claim 11, the method further comprising:
receiving an acceptance of the offer to automatically assist park the vehicle;
in response to receiving the acceptance of the offer to automatically park the vehicle, executing automatic parking assist to determine an available parking space; and
in response to determining the available parking space, parking the vehicle in the available parking space.

17. The method according to claim 11, wherein the behavior characteristics include driver gaze and head position, driver posture, driver eye openness, learned driver behavior, and vehicle speed.

18. The method according to claim 11, wherein the parking situation characteristics include driver gaze and head position, parking environment, point in journey, and vehicle location.

19. The method according to claim 11, the method further comprising:
in response to the behavior characteristic score being greater than the first predetermined threshold and the parking situation characteristic score being greater than the second predetermined threshold, determining whether a no parking intention condition is met; and
in response to determining the no parking intentions condition is not met, generating the notification regarding the offer to automatically assist parking the vehicle.

20. The method according to claim 11, the method further comprising:
determining whether a no parking intention condition is met; and
in response to determining the no parking intention condition is not met,
for each of the plurality of behavior characteristics,
determining the behavior confidence value, wherein the behavior confidence value indicates the likelihood of intention to park based on the behavior characteristic; and
determining the partial behavior characteristic score based on the behavior confidence value and the weight associated with the behavior characteristic;
determining the behavior characteristic score based on the partial behavior characteristic scores;
for each of the plurality of parking situation characteristics,
determining the parking situation confidence value, wherein the parking situation confidence value indicates the likelihood of intention to park based on the parking situation characteristic; and
determining the partial parking situation characteristic score based on the parking situation confidence value and the weight associated with the parking situation characteristic;
determining the parking situation characteristic score based on the partial parking situation characteristic scores; and
in response to the behavior characteristic score being greater than the first predetermined threshold and the parking situation characteristic score being greater than the second predetermined threshold, generating the notification regarding the offer to automatically assist parking the vehicle.
